(19) United States
(12) Patent Application Publication
(10) Pub. No.: US 2009/0178468 A1
(43) Pub. Date: Jul. 16, 2009

(54) SYSTEMS AND METHODS FOR DETERMINING STEAM TURBINE OPERATING EFFICIENCY

(75) Inventors: Tao Guo, Niskayuna, NY (US); Douglas C. Hofer, Clifton Park, NY (US); William J. Summer, Ballston Spa, NY (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/971,954

(22) Filed: Jan. 10, 2008

(51) Int. Cl. G01N 25/60; G01M 19/00

(52) U.S. Cl. 73/25.04; 73/29.03; 73/113.01

(57) ABSTRACT

A method for calculating moisture loss in a steam turbine operating under wet steam conditions. The method may include the steps of: 1) assuming equilibrium expansion, calculating a flow field initialization to determine initial pressure values, initial expansion rate, initial velocity values at an inlet and an exit of each of a plurality of bladerows in the steam turbine, and initial enthalpy values through each of the plurality of bladerows in the steam turbine; 2) using the initial pressure values, the initial velocity values, and the initial enthalpy values, calculating an initial subcooling ΔT value through each of the plurality of bladerows of the steam turbine; 3) calculating an Wilson Point critical subcooling ΔT value through each of the plurality of bladerows of the steam turbine required for spontaneous nucleation to occur based on the initial pressure value and the initial expansion rate; and 4) comparing the initial subcooling ΔT values to the Wilson Point critical subcooling ΔT values to determine where spontaneous nucleation occurs through the plurality of bladerows of the steam turbine.

### BACKGROUND OF THE INVENTION

This present application relates generally to methods and systems for determining steam turbine efficiency. More specifically, but not by way of limitation, the present application relates to methods and systems for determining moisture loss in steam turbines operating under wet steam conditions.

With ever rising energy costs and demand, increasing the efficiency of power generation with steam turbines is a significant objective. Because steam turbines often operate under wet steam conditions, a full understanding of the effect this has on turbine performance is required for the design of more efficient turbines.

Traditionally, due to the complex nature of the two-phase (i.e., flow that includes water vapor and droplets) flow phenomena, the moisture loss models used in the turbine design and analysis tools rely on empirical correlations that are based on overall turbine flow parameters. One such example is the well known Baumann's Rule, which provides that 1% average wetness present in a stage was likely to cause 1% decrease in stage efficiency. Another example can be found in the paper of Miller et al. where the wet steam turbine efficiencies were correlated to the average wetness fractions in the turbine.

Advances in computer hardware and CFD technology have made it possible to use more complicated two-phase flow models for analyzing the moisture losses in the turbines. Recently, Dykas and Wroblewski conducted numerical study of the effects of nucleation on the losses in LP turbine stages. In their CFD approach, averaged Navier-Stokes equations, combined with mass/energy conservation equations between gas and liquid phases, are solved for the flow field. Auxiliary equations for nucleation and droplet growth are coupled with the flow field to simulate the two-phase condensing flow. Instead of using real steam properties, a simplified gas property model is used to keep the overall numerical algorithm from being overly complicated.

However, neither the traditional empirical approach nor the CFD technology is suitable for turbine flow path design optimization. Since the empirical approach only concerns the overall flow parameters, it generally will not be able to identify the effect of design changes in the flowpath (such as stage count, reaction, flow turning, etc.) on the moisture losses. In regard to the CFD approach, it usually takes several days, if not weeks, to complete a meaningful study, which makes the approach unsuitable for design optimization where a large number of design options need to be explored within a limited time frame.

As such, there is a need for a more effective and efficient method to analyze potential moisture loss in a steam turbine operating under wet steam conditions. Such a method should capture all of the major loss mechanisms encountered in nucleating wet steam expansions while also being straightforward enough to allow the valuation of many design options within a reasonable timeframe. The combination of such a moisture loss determination method with existing steam path design tools likely will improve the understanding of moisture loss in steam turbines and provide significant insight into flowpath design optimization.

### BRIEF DESCRIPTION OF THE INVENTION

The present application thus describes a method for calculating moisture loss in a steam turbine operating under wet steam conditions. The method may include the steps of: 1) assuming equilibrium expansion, calculating a flow field initialization to determine initial pressure values, initial expansion rate, initial velocity values at an inlet and an exit of each of a plurality of bladerows in the steam turbine, and initial enthalpy values through each of the plurality of bladerows in the steam turbine; 2) using the initial pressure values, the initial velocity values, and the initial enthalpy values, calculating an initial subcooling ΔT value through each of the plurality of bladerows of the steam turbine; 3) calculating an Wilson Point critical subcooling ΔT value through each of the plurality of bladerows of the steam turbine required for spontaneous nucleation to occur based on the initial pressure value and the initial expansion rate; and 4) comparing the initial subcooling ΔT values to the Wilson Point critical subcooling ΔT values to determine where spontaneous nucleation occurs through the plurality of bladerows of the steam turbine. In some embodiments, the step of calculating the Wilson Point critical subcooling ΔT includes the steps of: 1) developing a first transfer function, the first transfer function being derived by using at least a plurality of measured Wilson critical subcooling ΔT values from available experimental data and correlating the Wilson Point critical subcooling ΔT value as a function of a Wilson Point expansion rate and a Wilson Point pressure value; and 2) calculating the Wilson Point critical subcooling ΔT value with the first transfer function by using the initial expansion rate as the Wilson Point expansion rate and the initial pressure value as the Wilson Point pressure value.

The present application further describes a system for calculating moisture loss in a steam turbine operating under wet steam conditions. The system may include: 1) means for, assuming equilibrium expansion, calculating a flow field initialization to determine initial pressure values, initial expansion rate, initial velocity values at an inlet and an exit of each of a plurality of bladerows in the steam turbine, and initial enthalpy values through each of the plurality of bladerows in the steam turbine; 2) means for, using the initial pressure values, the initial velocity values, and the initial enthalpy values, calculating an initial subcooling ΔT value through each of the plurality of bladerows of the steam turbine; 3) means for calculating an Wilson Point critical subcooling ΔT value through each of the plurality of bladerows of the steam turbine required for spontaneous nucleation to occur based on the initial pressure value and the initial expansion rate; and 4) means for comparing the initial subcooling ΔT values to the Wilson Point critical subcooling ΔT values to determine where spontaneous nucleation occurs through the plurality of bladerows of the steam turbine. In some embodiments, the system further includes a first transfer function that is derived by using at least a plurality of measured Wilson critical subcooling ΔT values from available experimental data and correlating the Wilson Point critical subcooling ΔT value as a function of a Wilson Point expansion rate and a Wilson Point pressure value. In such embodiments, the system may also include means for calculating the Wilson Point critical subcooling ΔT value with the first transfer function by using the initial expansion rate as the Wilson Point expansion rate and the initial pressure value as the Wilson Point pressure value. These and other features of the present application will become apparent upon review of the following detailed description of the preferred embodiments when taken in conjunction with the drawings and the appended claims.

### BRIEF DESCRIPTION OF THE DRAWINGS

FIG. 1 is a graph illustrating the process of homogenous nucleation and the determination of the Wilson Point.

FIG. 2 is a Mollier Chart illustrating a summary of available experimental Wilson Point data.

FIG. 3 is a graph illustrating the Wilson Point critical subcooling ΔT required for spontaneous nucleation as a function of both the local pressure and expansion rate.

FIG. 4 is a graph illustrating the average fog drop size produced from the nucleation as a function of both the local pressure and expansion rate.

FIG. 5 is a graph illustrating changes of subcooling ΔT as a function of drop size and expansion rate.

FIG. 6 is a graph illustrating changes of thermodynamic loss factor (loss/AE_{row}) as a function of droplet size and the expansion rate.

FIG. 7 is a flow diagram demonstrating an embodiment of the current application.

### DETAILED DESCRIPTION OF THE INVENTION

As one skilled in the art will appreciate, losses induced by the moisture content in the flowpath of a steam turbine have long been realized and studied. The losses associated with moisture content can be described with the following categories: nucleation losses, supersaturation losses, and mechanical losses.

### Nucleation Losses

The behavior of the wet steam as it expands through a steam turbine is considerably different than the idealized 2-phase system dealt with in equilibrium thermodynamics. The expansion rate is generally too rapid for equilibrium saturation conditions to be maintained. As a result, the vapor usually becomes supersaturated as it expands. That is, the vapor temperature drops below the corresponding saturation temperature at the local pressure. The level of supersaturation at any point during the expansion is defined by the local subcooling ΔT:

ΔT=T_{g}(P)−T_{g}

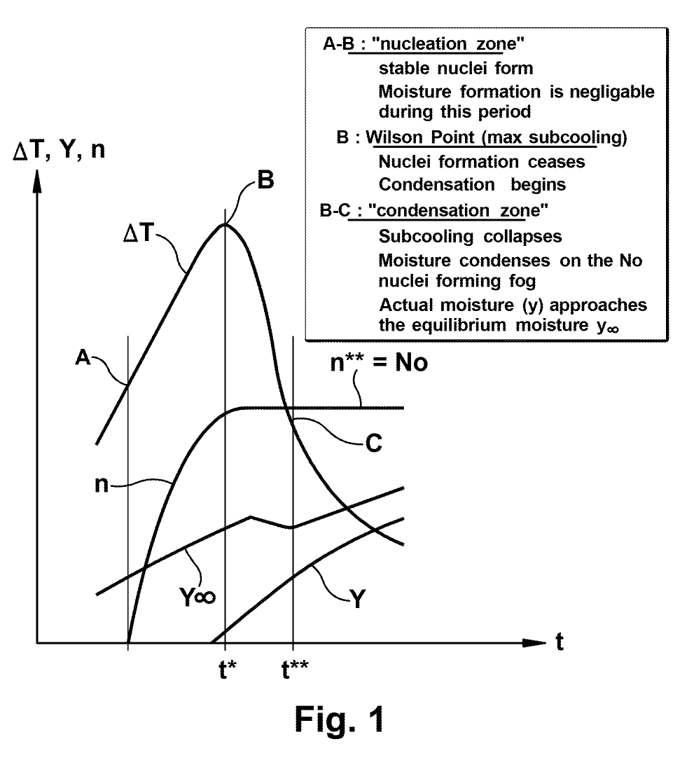

When the subcooling ΔT reaches a critical level the formation of supercritical liquid clusters will begin at an extremely high rate. This spontaneous nucleation of critical drops will result in a sudden collapse of the subcooling ΔT and a reversion towards equilibrium resulting in the formation of moisture with nearly uniform water droplets. This is the process of homogeneous nucleation. The maximum subcooling ΔT attained at the beginning of the reversion (i.e. point B in FIG. 1 designated ΔT) is commonly referred to as the Wilson Point. This process is illustrated in FIG. 1.

The location of the Wilson Point and the properties of the resulting nucleated fog are of primary importance to the turbine steam path designer. The diameter and number of fog drops (hence nucleated moisture) formed during the nucleation process will have a major influence on the aerodynamic and thermodynamic losses generated in the turbine. Much analytical and experimental work has been done since 1960 to develop a better understanding of the thermodynamics and flow phenomena associated with nucleating wet steam expansions. This work includes Gyarmathy, G., 1962, “Grundlagen einer Theorie der Nassdampfturbine,” Doctoral Thesis No. 3221, ETH, Zurich (English translation USAF-FTD (Dayton, Ohio) Rept. TT-63-785), which is incorporated herein in its entirety. With regard to nucleation, Gyarmathy showed the location of the Wilson Point and the resulting characteristics of the condensed fog depend primarily on the local pressure level and the expansion rate defined as

$$Pdot = - \frac{1}{P} \frac{\partial P}{\partial t}$$

which has the units l/sec. Gyarmathy also showed that the average size of the fog droplets emerging from the condensation phase of the nucleation depends on the local pressure level and expansion rate.

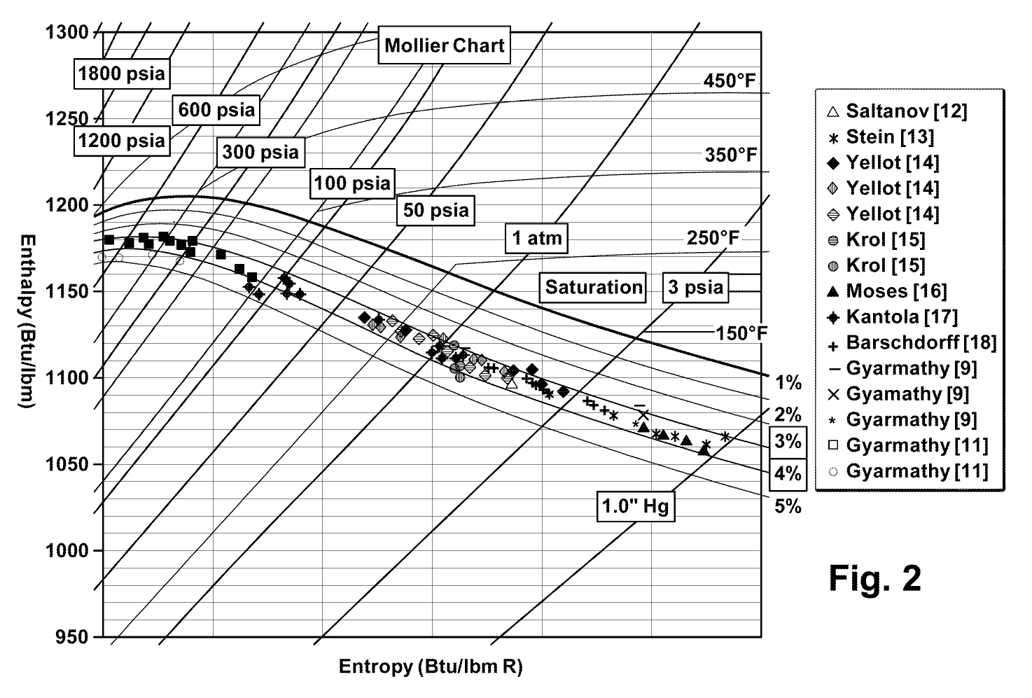

Numerous experimental investigations of homogeneous nucleation in Laval nozzles have been conducted over the years. Gyarmathy's experimental work as well of the works of many others (see FIG. 2 summary) have collectively validated the analytical findings. (Note: the FIG. 2 summary corresponds with the following list of publicly available experimental data: [9] Gyarmathy, G., and Meyer, H., 1965, “Spontane Kondensation.” VDI Forschungsheft 508, VDI-Verlag, Düsseldorf; [11] Gyarmathy, G., 2005, “Nucleation of Steam In High-Pressure Nozzle Experiments”, ETC 6th European Conf on Turbomachinery, March 7-11, Lille, France; [12] Saltanov, G. A., Seleznev, L. J. and Tsiklauri, G. V., 1973, “Generation and Growth of Condensed Phase in High-Velocity Flows”, Int Jo Heat Mass Transfer, 16, pp. 1577-1587; [13] Stein, G. D. and Moses, C. A., 1972, “Rayleigh Scattering Experiments on the Formation of Water Clusters Nucleated from Vapor Phase”, J. Colloid. Interfac. Sci., 39, pp. 504-512; [14] Yellot, J. I., 1934, “Supersaturated Steam”, Trans. ASME, 56, pp. 411-430; [15] Krol, T., 1971, “Results of Optical Measurements of Diameters of Drops Formed Due to Condensation of Steam in a Laval Nozzle”, (in Polish), Trans. Inst. Fluid Flow Mech. (Poland), No. 57, pp. 19-30; [16] Moses, C. A. and Stein, G. D., 1978, “On the growth of steam droplets formed in a laval nozzle using both static pressure and light scattering measurements”, ASME J. Fluids Eng., 100, pp 311-322; [17] Kantola, R A, 1982, “Steam Condensate Droplet Evolution: Experimental Technique”, 82CRD163; and [18] Barschdorff, D., Hausmann, G. and Ludwig, A., 1976, “Flow and Drop Size Investigations of Wet Steam at Sub and Supersonic Velocities with the Theory of Homogeneous Condensation”, Pr. Inst. Maszyn Przeplwowych, 241, pp 70-72, all of which are incorporated herein in their entirety.)

The Wilson Point moisture deficit data displayed in FIG. 2 demonstrates the comprehensive nature of the available experimental data. A wide range of inlet pressures (2 to 2148 psia), entropies (˜1.384 to 1.934 btu/lbmoR) and expansion rates (˜300 to 230000 l/sec) are represented by this data which more than covers the range of steam conditions encountered with modern day steam turbines. Modeling of the nucleation process based on the test data will be discussed later.

### Supersaturation Losses

Based on the homogeneous nucleation theory discussed previously, it is generally acceptable to assume that immediately after the nucleation the fog droplet distribution is mono-dispersed and the droplets/steam mixture is in thermal equilibrium, i.e., the droplets are at the same temperature as the steam. Besides, since the fog droplet sizes within a properly designed turbine flowpath are generally very small (within sub-micron ranges), the fog droplets/steam mixture can also be considered as in inertial equilibrium, where the velocity slips between the phases are negligible.

As the two-phase mixture continues expanding downstream of the nucleation through the nozzle and bucket rows, the thermal equilibrium assumption is usually no longer valid. In an expansion process, as the pressure of the steam decreases, the temperature of the steam will decrease accordingly, causing more steam to condense on the existing droplets (droplet growth). If the expansion rate is slow, the heat generated from the condensation can be transferred from the droplets to the steam fast enough to keep minimum temperature difference between the two phases. However, the expansion process in the turbine blade channels is often so fast that the heat transfer rate between the droplets and the steam lags behind, causing the temperature of the droplets to be much higher than the surrounding steam. The resulting temperature difference not only provides the driving force for condensation and the possible second nucleation, but also is responsible for an overall entropy increase of the flow and a reduction in turbine efficiency. The loss associated with this inter-phase temperature difference is often referred as Supersaturation Loss or Thermodynamic Wetness Loss.

### Mechanical Losses

As the fog droplets move through the flowpath, some of them may collide or coalesce. Some will come into contact with the blade surface and either bounce off or deposit on it. The deposited droplets then generally form water films/rivulets that are drug toward the blade's trailing edge under the shear force of the main flowpath. The water film/rivulets will eventually be torn off at the blade's trailing edge and break up into water droplets again, thus forming so-called secondary drops (to distinguish them from the primary or fog droplets generated from nucleation). This water film/rivulets torn-off and break up process is also called secondary drop “atomization”.

The largest stable secondary drop sizes from “atomization” are controlled by the critical Weber number, which is defined as the ratio of aerodynamic pressure force over the liquid surface tension:

$$We = \frac{{ρ}_{g} {V}_{r} d}{σ}$$

Where ρ_{g} is the density of the vapor phase, σ is the liquid phase surface tension, Vᵣ is the relative velocity between the phases, and d is the corresponding drop diameter. The critical We number under normal LP turbine flow conditions is in the range of 20-22, which results in secondary drop sizes ranging from several microns to hundreds of microns inside a typical LP section of a steam turbine (compared to the fog drop sizes which are usually in the sub-micron range).

The “atomized” secondary drops, moving much slower than the main steam flow, will then be accelerated by the main flow within the gap between the bladerows before they reach the leading edge of the next row. The velocities of the secondary drops entering the next bladerow will in general attain only a fraction of the main steam velocity. However, for small secondary drops, their velocities can approach the main steam velocity, as commonly seen in HP steam turbines.

The loss associated with the acceleration of the secondary drops is called Inter-phase Drag Loss, and is one of the major sources of mechanical losses.

Entering the next row, the secondary drops must be treated differently depending on their sizes. For small secondary drops, they tend to follow the main flow and behave like fog droplets. For large secondary drops, most of them will impact on the blade surface. They can either adhere to the surface, adding to the deposited water from the fog droplets, or rebound into the main flow as smaller drops.

For secondary drops entering a rotating bladerow, many of them will be impinging on the leading edge of the airfoil surface, especially on the suction side by the larger secondary drops due to their slower velocities than the main flow [7,19]—exerting a “braking” effect on the rotating row. The loss associated with the reduction of the blade work due to “braking” effect is called Braking Loss, which is another major source of mechanical losses.

Furthermore, within the rotating bladerow, the water film/rivulets from deposition will also be moving radially towards the blade tip under the centrifugal force, in addition to being dragged axially toward the blade trailing edge. As a result, some of the work output is wasted to increase the momentum of the water film/rivulets. This loss is usually called blade Pumping Loss, which is the third major mechanical loss.

### Deposition & its Effects on Moisture Losses

As discussed earlier, the secondary drops originate from fog droplets deposition, and are generally known to be the main contributors to the inter-phase drag and the blade braking and pumping losses. Therefore understanding of the droplet deposition process is necessary for the moisture loss determination.

In general, fog droplet deposition on turbine blades occurs in two ways: by both inertial impaction and turbulent diffusion through boundary layers. To aid for further discussion, a brief summary of the two deposition mechanisms is given here. A detailed description of the deposition processes can be found in Crane, R. I., 1973, “Deposition of Fog Drops on Low Pressure Steam Turbines,” Int. J. Mech. Sci., 15, pp 613-631, which is incorporated herein in its entirety. Recent calculations of both types of deposition are given by Young, J. B. and Yau, K. K., 1988, “The Inertial Deposition of Fog Droplets on Steam Turbine Blades,” ASME J. Turbomachinery, 110, pp 155-162; and Yau, K. K and Young, J. B., 1987, “The Deposition of Fog Droplets on Steam Turbine Blades by Turbulent Diffusion,” ASME J. Turbomachinery, 109, pp 429-435, which are both incorporated herein in their entirety.

Inertial impaction deposition refers to the flow phenomenon where the droplets are unable to follow exactly the curved main steam streamlines within the flowpath. Therefore, the rate of deposition is a strong function of droplet size. The bigger the droplet, the greater its chance of deviating from the steam streamline, and thus, a larger deposition rate exists. Theoretically, the deposition rate can be calculated by tracking the particle paths followed by each individual droplet under a given steam flow field. One such example can be found in Yau, K. K and Young, J. B., 1987, “The Deposition of Fog Droplets on Steam Turbine Blades by Turbulent Diffusion,” ASME J. Turbomachinery, 109, pp 429-435. Normally, the blade's leading edge and the area near the trailing edge of the pressure surface are the two likely places for the inertial-impaction deposition to happen since these are the areas where the steam streamlines turn the most.

Turbulent diffusion deposition refers to the flow phenomenon where the transport of fog droplets to the blade surface is by diffusion through the boundary layer. Basically, the small particles/droplets entrained in a turbulent boundary layer will migrate to the blade surface under the action of the turbulent velocity fluctuations of the gas phase. Since the blade suction surface usually has a thicker boundary layer, it is expected that the turbulent diffusion deposition should play a more important role on the suction side than on the pressure side of the blade.

It is noted that theoretical predictions made in Young, J. B. and Yau, K. K., 1988, “The Inertial Deposition of Fog Droplets on Steam Turbine Blades,” ASME J. Turbomachinery, 110, pp 155-162 have indicated the deposition rates from both deposition processes are of comparable magnitude in LP turbines.

### Moisture Loss Modeling within Steam Turbines

Due to the complicated nature of wet steam flow inside the turbine, fully numerical simulation of the condensing flow is, if not impossible, formidably time consuming and expensive, thus rendering limited value to the turbine designers. The traditional empirical approach, though simple, generally offers no insight into the moisture loss mechanisms, thus providing little guidance to the design improvement.

The present application provides a physics-based moisture loss determination system that may be effectively used for industrial applications. It is not intended for this new system to accurately calculate the details of all the aspects related to the moisture losses, but rather to provide the turbine designers an effective tool to evaluate the moisture loss effect on the turbine performance due to certain design changes.

### Nucleation Loss Modeling

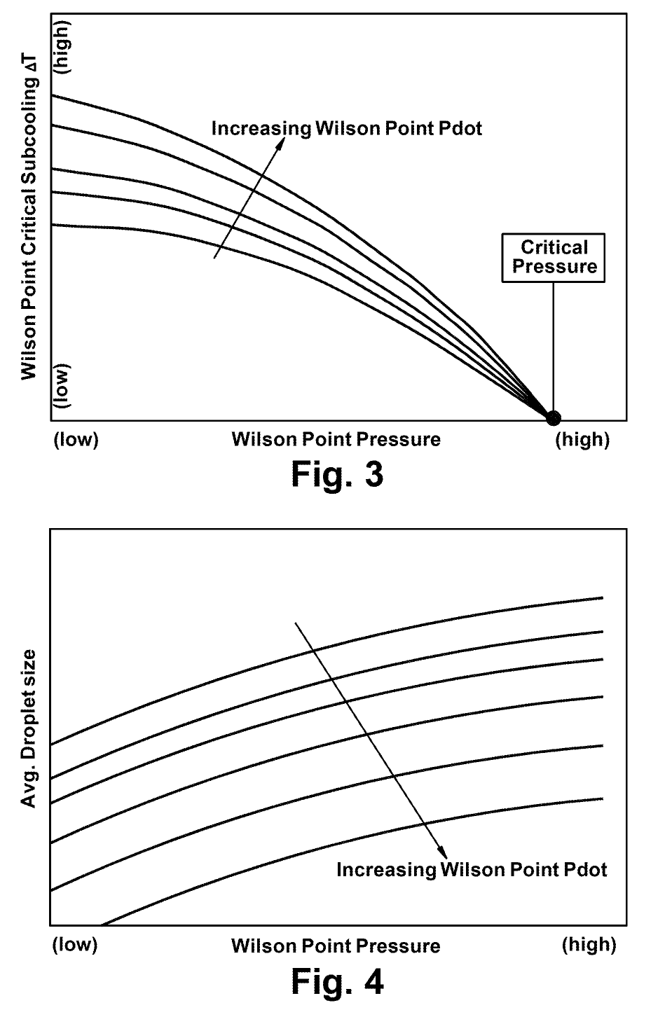

An objective of the current application is to describe the contributions of the nucleation process to the moisture losses while still being simple enough for industrial applications. To this end, as one of ordinary skill in the art will appreciate, the comprehensive database of experimental data identified in FIG. 2 may been used to successfully develop two transfer functions that capture the essentials of the nucleation process needed to accomplish a robust physics-based design. The first transfer function provides the means for determining the Wilson Point critical subcooling ΔT required for spontaneous nucleation as a function of both the local pressure and expansion rate. This transfer function may be derived by taking all or some of the measured Wilson critical subcooling ΔT values from the available experimental data listed in FIG. 2 and correlating the Wilson Point critical subcooling ΔT value as a function of the Wilson Point expansion rate and Wilson Point pressure value. The characteristics of this transfer function are illustrated in FIG. 3. When combined with a suitable gas solution for a bladerow, the local subcooling ΔT can be calculated and compared to the critical value ΔT required for nucleation to determine the location of the Wilson Point. The local state conditions (Twp, Pwp, Hwp, Swp) at that point are then determined using the metastable properties from the IAPWS-IF97 formulation. If we assume that reversion occurs under adiabatic conditions and constant pressure then we can determine the equilibrium moisture deficit at the Wilson Point using the equilibrium steam properties by noting that Hwp=Hmix. The entropy increase and associated thermodynamic loss caused by the nucleation are then determined from:

$$Δ {s}_{rev} = s ( {p}_{0} , {h}_{0} ) - {{s}_{wp} ( {p}_{wp} , {h}_{wp} )}_{metastable}$$

$${LF}^{**} = \frac{{T}_{sat} ( p ) \times Δ {S}_{rev}}{{AE}_{row}}$$

Where AE_{row} is the bladerow available energy which is defined here as the difference between the bladerow inlet total enthalpy and the bladerow isentropic exit static enthalpy.

The second transfer function provides the means for determining the average fog droplet size produced from the nucleation. The second transfer function is based on the available data produced in Laval nozzles as reported in the works that are listed in relation to FIG. 2. The second transfer function provides the means for determining the average fog droplet diameter produced from nucleation as a function of both the local pressure and expansion rate. This transfer function may be derived by taking all or some of the measured nucleation droplet sizes from the available experimental data listed in FIG. 2 and correlating the average droplet diameter as a function of the Wilson Point expansion rate and the Wilson Point pressure value. The characteristics of this transfer function are illustrated in FIG. 4.

FIG. 3 shows the Wilson Point subcooling ΔT increases as the expansion rate increases. It also shows that the degree of subcooling ΔT at the Wilson Point is lower in HP than that in LP turbines. FIG. 4 shows that to obtain small nucleation droplets, a high expansion rate is needed.

With the moisture deficit and average fog diameter defined we can now determine the number of droplets per unit mass of wet steam:

$${N}_{o} = \frac{3 Y}{4 {{πρ}_{l} ( 0.5 * {d}^{**} )}^{3}}$$

### Supersaturation Loss Modeling

The primary wet steam flow can be modeled reasonably well as a homogeneous mixture of vapor and tiny spherical water droplets. Assuming further that there is no velocity slip between the phases, the governing equations for the homogeneous wet steam flow can be written as:

$$\frac{\partial ρ}{\partial t} + ∇ \cdot ( ρ V ) = 0$$

$$\frac{\partial V}{\partial t} + ( V \cdot ∇ ) V + \frac{∇ p}{ρ} = 0$$

$$\frac{\partial }{\partial t} [ ρ ( e + \frac{{V}^{2}}{2} ) ] + ∇ \cdot [ ρ V ( h + \frac{{V}^{2}}{2} ) ] = 0$$

Where ρ is the density of the two-phase mixture, ρ=ρ_{g}/(1−y), ρ_{g} is the density of the vapor phase, y is the wetness fraction of the mixture, V is the mixture velocity, h is the mixture specific enthalpy.

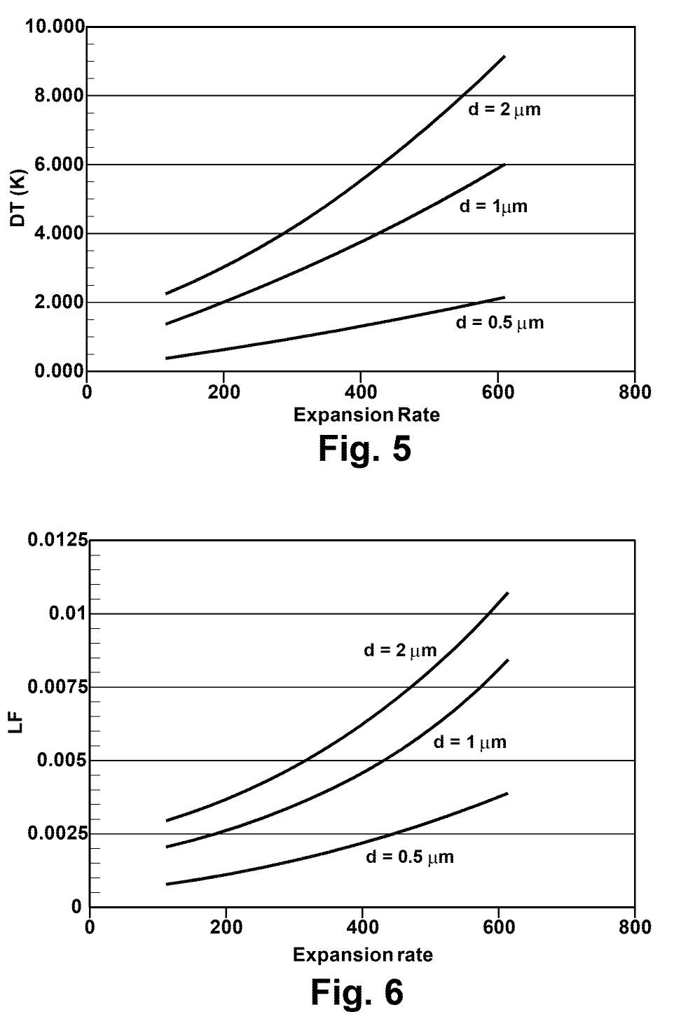

Instead of solving the above equations numerically which is a time consuming process, a semi-analytical approach may be used. For example, an approach developed by J. B. Young may be adopted. See Young, J. B., 1984, “Semi-Analytical Techniques for investigating Thermal Non-Equilibrium Effects in Wet Steam Turbines,” Int. J. Heat & Fluid Flow, 5, pp 81-91, which is incorporated herein in its entirety. FIGS. 5 and 6 show the changes of steam subcooling ΔT and the corresponding thermodynamic loss factor (loss/AE_{row}) as a function of droplet size and the expansion rate within a typical HP turbine nozzle row, using Young's approach. It can be seen that the supersaturation loss increases as either the droplet size or the expansion rate increases. Smaller droplets from nucleation are thus beneficial in reducing the moisture losses in the turbine.

### Mechanical Loss Modeling

The drag force acting on a given secondary drop generated from “atomization” at the bladerow trailing edge can be calculated from:

$${F}_{D} = \frac{1}{2} {ρ}_{g} {C}_{D} {A}_{s} {V}_{r}^{2} = \frac{1}{2} {ρ}_{g} {C}_{D} ( π {r}^{2} ) {V}_{r}^{2}$$

Where Vr is the relative velocity between the droplet and the steam, Vr=Vg−Vₗ, r is the droplet radius, C_{D} is the drag coefficient, which is given by Gyarmathy:

$${C}_{D} = \frac{24}{Re} \frac{1}{( 1 + 2.7 Kn )}$$

Where Kn (=l_{g}/d) is the Kndsen number of the droplet, with d is the droplet size, l_{g} is the mean free path of steam molecules.

The droplet trajectory can be tracked through Newton's Law:

$$\frac{4}{3} π {r}^{3} {ρ}_{l} \frac{d {V}_{l}}{d t} = \frac{1}{2} {ρ}_{g} {C}_{D} ( π {r}^{2} ) {V}_{r}^{2}$$

The above equation can be easily solved by numerical integration within the blade gap to obtain the secondary drop velocity at the leading edge of the next bladerow.

Once Vₗ is known, the mechanical losses associated with the secondary drops can be calculated by:

$$LF = \frac{{Q}_{2 nd}}{Q} ( \frac{{V}_{l}^{2}}{{V}_{0}^{2}} + \frac{{W}_{LE}^{2} - {W}_{LE} * {V}_{Tl}}{{V}_{0 }^{2}} ) + \frac{{Q}_{dep}}{Q} ( \frac{{W}_{TE}^{2} - {W}_{LE}^{2}}{{V}_{0}^{2}} )$$

Where V₀ is the bladerow isentropic velocity, W_{LE} and W_{TE} are the bladerow wheel speed at leading edge and trailing edge, respectively. V_{Tl} is the liquid tangential velocity, Q_{dep} is the flow rate of the deposited water, Q_{2nd} is the liquid flow rate at the bladerow trailing edge. The first term on the right side of the equation represents the drag loss, the second term represents the braking loss, and the third term represents the pumping loss.

### Deposition Rate Modeling

As indicated previously, the leading edge and the area near the trailing edge of the pressure surface of the blade are the two likely places for the inertial deposition to occur. At the blade leading edge, the droplet deposition is calculated using a model proposed in Gyarmathy, G., 1962, “Grundlagen einer Theorie der Nassdampfturbine,” Doctoral Thesis No. 3221, ETH, Zurich. English translation USAF-FTD (Dayton, Ohio) Rept. TT-63-785:

$${F}_{I 1} = {η}_{c} \frac{2 R}{{P}_{eff}}$$

Where R is the equivalent leading edge radius, P_{eff}=s*sin β is the effective blade pitch with s being the blade spacing and β being the inlet flow angle, η_{c} is the droplet collection efficiency which is calibrated numerically using the particle tracking approach. The inertial deposition within the blade channel is calculated based on an approach originally proposed by Gyarmathy and later modified in Young and Yau Young, J. B. and Yau, K. K., 1988, “The Inertial Deposition of Fog Droplets on Steam Turbine Blades,” ASME J. Turbomachinery, 110, pp 155-162:

$${F}_{12} = \frac{2 s}{P} ( 1 - α ) [ ( St ) - {( St )}^{2} ( 1 - {e}^{- 1 / St} ) ]$$

$$α = \frac{ω {c}^{2} sin ϕ}{{sW}_{m}} , St = \frac{τ {W}_{m}}{c} , τ = \frac{2 {r}^{2} {ρ}_{l}}{9 {μ}_{g}} [ φ ( Re ) + 2.7 Kn ]$$

$$φ ( Re ) = {[ 1 + 0.197 {Re}^{0.63} + 0.00026 {Re}^{1.38} ]}^{- 1}$$

where ω is the rotational speed, St is the Stokes number, τ is the inertial relaxation time, Wₘ and φ are the steam meridinal flow velocity and angle, respectively, c is the blade axial width.

For turbulent diffusion deposition, due to the complexity of this subject, a theoretical approach is not attempted. Empirical correlations have been developed based on a number of experimental studies in the past, including those for the prediction of turbulent diffusion deposition in 1D pipe flow. See Wood, N. B., 1981, “A Simple Method for the Calculation of Turbulent Deposition to Smooth and Rough Surfaces,” J. Aerosol Science, 12, pp. 275-290. For example, the deposition rate for a nuclear HP turbine can be estimated using the following correlation:

F_{Dt}=0.11d⁵−0.6d⁴+1.2d³−1.1d²+0.45d−0.033

where d is the droplet size, F_{Dt} is the fractional turbulent diffusion deposition rate.

Thus, in sum, for a given turbine layout, a moisture loss determination method may begin by going through all the bladerows to calculate the Wilson Point critical subcooling ΔT value and to identify the nucleation row. Once a nucleation row is identified, the primary droplet size and number counts as well as the wetness fraction may be obtained from the nucleation models. Then the droplet growth, the steam subcooling ΔT and the resulting thermodynamic loss may be calculated in the next bladerow using the supersaturation models. Droplet deposition for different size groups may also be calculated. Based on the deposition results, the size and number counts of the secondary drops generated at bladerow trailing edge may be obtained. Thus, the losses associated with the secondary drops may be calculated. With the calculated thermodynamics loss and the mechanical losses, the resulting moisture loss coefficient LF may then be applied to the bladerow efficiency calculation in the same manner as the normal aerodynamics loss coefficients. Finally, the size and number counts for both the primary and the secondary droplets are updated at the bladerow exit, and the same calculation procedure will be repeated in the next bladerow.

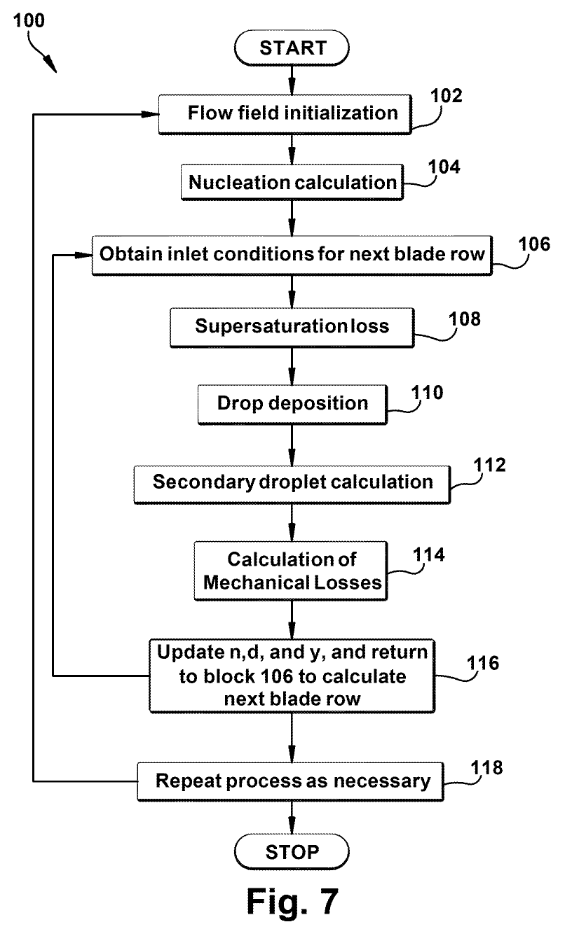

FIG. 7 is a flow diagram demonstrating an embodiment of the present invention, a moisture loss determination method 100. In some embodiments, the moisture loss determination method 100 may be implemented and controlled by an operating system. The operating system may comprise any appropriate high-powered solid-state switching device. The operating system may be a computer; however, this is merely exemplary of an appropriate high-powered control system, which is within the scope of the application. For example, but not by way of limitation, the operating system may include at least one of a silicon controlled rectifier (SCR), a thyristor, MOS-controlled thyristor (MCT) and an insulated gate bipolar transistor. The operating system also may be implemented as a single special purpose integrated circuit, such as ASIC, having a main or central processor section for overall, system-level control, and separate sections dedicated performing various different specific combinations, functions and other processes under control of the central processor section. It will be appreciated by those skilled in the art that the operating system also may be implemented using a variety of separate dedicated or programmable integrated or other electronic circuits or devices, such as hardwired electronic or logic circuits including discrete element circuits or programmable logic devices, such as PLDs, PALs, PLAs or the like. The operating system also may be implemented using a suitably programmed general-purpose computer, such as a microprocessor or microcontrol, or other processor device, such as a CPU or MPU, either alone or in conjunction with one or more peripheral data and signal processing devices. In general, any device or similar devices on which a finite state machine capable of implementing the logic flow diagram 200 may be used as the operating system. As shown a distributed processing architecture may be preferred for maximum data/signal processing capability and speed.

At a block 102, a flow field initialization is performed. As one ordinary skill in the art will appreciate, a flow field initialization may be completed with any conventional one dimensional (1D pitchline), quasi-two dimensional (quasi-2D) or two dimensional (2D) steam path performance prediction methods or codes, such as SXS, MFSXS or other similar software programs. The flow field initialization assumes equilibrium expansion—i.e., one phase “dry” steam flow through the several bladerows of the steam turbine. Thus, given the operational parameters of the steam turbine and the equilibrium expansion assumption, the flow field initialization will provide initial pressure, enthalpy (i.e., temperature) and velocity values at the inlet and exit of each bladerow, and an initial expansion rate value for the steam flow through each bladerow of the steam turbine. Using the initial pressure values, an initial steam subcooling ΔT value, which represents the temperature differential between the steam and the corresponding saturation temperature (i.e., the temperature at which the steam reaches saturation) at the local steam pressure, can be calculated anywhere within the steam path.

At a block 104 a nucleation calculation is made. The nucleation calculation may include several related calculations, culminating in a determination of the nucleation loss in the relevant bladerow. First, a determination of where spontaneous nucleation occurs, i.e., the bladerow in the steam turbine in which spontaneous nucleation first occurs. A bladerow is defined to be either a row of nozzles or a row of turbine blades or buckets. A steam turbine may have multiple stages, each of which contain a row of nozzles followed by a row of buckets. As described above, from the available Wilson Point experimental data, a graph or transfer function may be developed that determines the Wilson Point critical subcooling ΔT required for spontaneous nucleation as a function of both local pressure and expansion rate. (See FIG. 3 and accompanying description above.) Using the initial pressure value and the initial expansion rate calculated at block 102, a Wilson Point critical subcooling ΔT may be calculated for each point along the flow path within the turbine. The calculated Wilson Point critical subcooling ΔT then may be compared to the calculated initial subcooling ΔT value. Where the initial subcooling ΔT value is less than the Wilson Point critical subcooling ΔT, no spontaneous nucleation will occur. Whereas, where the initial subcooling ΔT value is greater than or equal to the Wilson Point critical subcooling ΔT, spontaneous nucleation will occur. As such, the bladerow where spontaneous nucleation occurs may be determined by this comparison. For example, a conventional steam turbine may have nine stages and the nucleation calculation may determine that spontaneous nucleation occurs in the bucket bladerow of stage two. For the sake of clarity, this example will be carried through the remaining description of the moisture loss determination method 100.

Second, the nucleation calculation may include a determination of drop size. As described above, from the available Wilson Point experimental data, a second graph or second transfer function may be developed that provides the means for determining the average drop size as a function of both local pressure and expansion rate. (See FIG. 4 and accompanying description above.) Using the initial pressure value and the initial expansion rate, drop size may be calculated within the nucleation bladerow. Third, the nucleation calculation may include a determination of the number of drops formed by the spontaneous nucleation, pursuant to the methods described above. So, continuing the example above, the drop size and number of drops in the bladerow where spontaneous nucleation first occurred—i.e., the bucket bladerow of stage two—may be calculated.

Fourth, the nucleation calculation may include a determination of y, the wetness fraction, which may represent the wetness fraction of the mixed flow, i.e., the percentage of water droplets in the mixed flow of water droplets and steam. This may be done pursuant to the methods described above. Fifth, and finally, the nucleation calculation may include the determination of the nucleation loss in the bladerow where spontaneous nucleation first occurred. Thus, the nucleation loss for the bucket row of stage two may be calculated pursuant to the methods described above.

The process may then proceed to a block 106, where the inlet conditions for the next bladerow may be determined, which, to continue the example above, would mean determining the inlet conditions for the nozzle row of stage three. The inlet conditions may include PT (pressure total), HT (enthalpy total), ΔT (subcooling), n (number of droplets), d (diameter of drops), y (wetness fraction or the percentage of water compared to the whole flow). The PT value may equal the pressure as calculated in the flow field initialization of block 102 for the current bladerow inlet location. The HT value may equal the enthalpy as calculated in the flow field initialization of block 102 for the current bladerow inlet location. ΔT, which represents the temperature differential between the steam and water droplets, is assumed to be zero at the inlet of the bladerow that follows the bladerow in which spontaneous nucleation first occurs, because, as one of ordinary skill in the art would appreciate, the temperature differential between the steam and water droplets immediately after spontaneous nucleation is negligible. It should be noted here that if the bladerow does not directly follow the nucleation bladerow, the ΔT may be a non-zero value. The remaining inlet conditions—n, d, and y—may equal the values determined above in the nucleation calculation. Thus, to continue with the example, the number of drops, drop size and wetness fraction inlet conditions for the nozzle bladerow of stage three may equal the values calculated for the bucket bladerow of stage two.

At a block 108, with the inlet conditions determined, the supersaturation loss across the nozzle bladerow of stage three may be calculated. As stated, subcooling ΔT is assumed to be zero at the inlet of the nozzle bladerow of stage three. However, as the flow expands across the nozzle bladerow of stage three a temperature differential builds between the water droplets and the steam. It is this increasing temperature differential that causes a change in entropy and a decrease in turbine efficiency, which is the supersaturation loss. As described above, a semi-analytical approached developed in Young, J. B., 1984, “Semi-Analytical Techniques for investigating Thermal Non-Equilibrium Effects in Wet Steam Turbines,” Int. J. Heat & Fluid Flow, 5, pp 81-91 may be used to determine the subcooling ΔT and the resulting loss in efficiency. This approach includes the use of the following equations:

$$Δ T = Δ {T}_{0} {e}^{- t / {τ}_{T}} + {τ}_{T} F \dot{P} ( 1 - {e}^{- t / {τ}_{T}} )$$

$$y - {y}_{0} = \frac{( 1 - y ) {c}_{pg}}{{h}_{fg}} [ ( Δ {T}_{0} - Δ T ) + F \dot{P} t ]$$

$$Δ {s}_{TE} = \frac{( 1 - y ) {c}_{pg}}{{T}_{s}^{2}} \{ \frac{Δ {T}^{2}}{2} ( 1 - {e}^{- 2 t / {τ}_{T}} ) + {τ}_{T} F \dot{P } Δ {T ( 1 - {e}^{- t / {τ}_{T}} )}^{2} + {( {τ}_{T} F \dot{P} )}^{2} [ \frac{t}{{τ}_{T}} - 2 ( 1 - {e}^{- t / {τ}_{T}} ) + \frac{1}{2} ( 1 - {e}^{- 2 t / {τ}_{T}} ) ]$$

where y steam wetness fraction
ΔTₓ subcooling
Δs_{TE} corresponding thermodynamic loss
ΔT₀ initial steam excess subcooling
y₀ initial wetness fraction
α coefficient of thermal expansion of the steam
h_{fg} latent heat
C specific heat of the mixture
τ_{T} thermal relaxation time

At a block 110, drop deposition may be determined for the nozzle bladerow of stage three. Thus, the amount of water that deposits onto the nozzle blades of that bladerow may be calculated pursuant to the approach previously described.

At a block 112, a secondary drop calculation may be made, pursuant to the approach previously described. This calculation will determine the number and size of the secondary drops formed at the trailing edge of the current bladerow as a result of the deposition of water on the nozzle bladerow of stage three.

At a block 114, the mechanical losses associated with the secondary drops may be calculated for the nozzle row of stage three. Continuing with the example above, because it is a nozzle bladerow (i.e., a stationary part), there will be no pumping or braking losses. Those types of losses occur only on bucket bladerows. The drag loss, which describes the loss associated with the flow accelerating the secondary drops as the drops are torn off of the nozzle, may be calculated pursuant to the approach previously described.

At a block 116, n (number of droplets), d (diameter of drops), y (wetness fraction or the percentage of water compared to the total flow rate) at the exit of the current bladerow (and consequently at the inlet of the next bladerow) may be updated. Continuing with the example above, with those values updated, the method may return to block 106, where the calculation of the supersaturation and mechanical losses for the next blade row, which would be the bucket bladerow for the third stage, may be calculated. Note that the inlet subcooling ΔT value for the bucket bladerow for the third stage will not be assumed to be zero (because it is not the next bladerow after spontaneous nucleation). Instead, the subcooling ΔT value calculated in the supersaturation loss calculation of block 108 for the previous bladerow will be used. Further, because the current bladerow is a bucket bladerow, breaking and pumping losses will be calculated, which will be based upon the deposition of secondary drops on the buckets.

The moisture loss determination method 100 will then cycle through block 106 and block 116 until the supersaturation and mechanical losses have been calculated for all of the bladerows downstream of the nucleation bladerow. Thusly, all three components of moisture losses, i.e., the nucleation loss, supersaturation loss, and mechanical loss, will have been calculated for all of the stages of the steam turbine.

Once the method has calculated the supersaturation and mechanical losses for the downstream bladerows, the methods may proceed to a block 118. In some embodiments, as shown in FIG. 7, the method may return to block 102 to begin an iterative process for more accurate results. If this is the case, the flow field initialization may be completed again in a second pass with the calculated moisture losses from the first pass. The flow field calculated at block 102 from this second pass then may be used to again calculate the moisture losses as was done in the first pass. Additional iterations may be completed as necessary until the moisture loss values converge, which generally will occur within 3-10 passes. In this manner, moisture loss in steam turbines operating under wet steam conditions may be accurately and efficiently predicted, which may be a useful tool in the design of more efficient steam turbines.

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A method for calculating moisture loss in a steam turbine operating under wet steam conditions, the method comprising the steps of:
assuming equilibrium expansion, calculating a flow field initialization to determine initial pressure values, initial expansion rate, initial velocity values at an inlet and an exit of each of a plurality of bladerows in the steam turbine, and initial enthalpy values through each of the plurality of bladerows in the steam turbine;
using the initial pressure values, the initial velocity values, and the initial enthalpy values, calculating an initial subcooling ΔT value through each of the plurality of bladerows of the steam turbine;
calculating an Wilson Point critical subcooling ΔT value through each of the plurality of bladerows of the steam turbine required for spontaneous nucleation to occur based on the initial pressure value and the initial expansion rate; and
comparing the initial subcooling ΔT values to the Wilson Point critical subcooling ΔT values to determine where spontaneous nucleation occurs through the plurality of bladerows of the steam turbine.

2. The method according to claim 1, wherein the step of calculating the Wilson Point critical subcooling ΔT includes the steps of:
developing a first transfer function, the first transfer function being derived by using at least a plurality of measured Wilson critical subcooling ΔT values from available experimental data and correlating the Wilson Point critical subcooling ΔT value as a function of a Wilson Point expansion rate and a Wilson Point pressure value; and
calculating the Wilson Point critical subcooling ΔT value with the first transfer function by using the initial expansion rate as the Wilson Point expansion rate and the initial pressure value as the Wilson Point pressure value.

3. The method according to claim 2, wherein the measured Wilson critical subcooling ΔT values from the available experimental data includes at least one of the sources described herein in relation to FIG. 2.

4. The method according to claim 2, wherein the first transfer function comprises the same relationships between the Wilson Point critical subcooling ΔT value, the Wilson Point expansion rate, and the Wilson Point pressure value as that illustrated in FIG. 3.

5. The method according to claim 4, wherein the first transfer function provides a direct relationship between the Wilson Point critical subcooling ΔT value and the Wilson Point expansion rate.

6. The method according to claim 1, wherein the step of comparing the initial subcooling ΔT value to the Wilson Point critical subcooling ΔT to determine where spontaneous nucleation occurs through the plurality of bladerows of the steam turbine comprises:
determining that spontaneous nucleation does not occur within one of the bladerows if the initial subcooling ΔT value is less than the Wilson Point critical subcooling ΔT; and
determining that spontaneous nucleation does occur within one of the plurality of bladerows if the initial subcooling ΔT value is greater than or equal to the Wilson Point critical subcooling ΔT.

7. The method according to claim 1, further comprising the step of calculating an average droplet size in the bladerow where spontaneous nucleation occurs.

8. The method according to claim 7, wherein the step of calculating the average droplet size in the bladerow where spontaneous nucleation occurs includes the steps of:
developing a second transfer function, the second transfer function being derived by using at least a plurality of measured droplet sizes from available experimental data and correlating the average droplet size as a function of a Wilson Point expansion rate and a Wilson Point pressure value; and
calculating the average droplet size with the second transfer function by using the initial expansion rate as the Wilson Point expansion rate and the initial pressure value as the Wilson Point pressure value.

9. The method according to claim 8, wherein the measured nucleation droplet sizes from the available experimental data includes at least one of the sources described herein in relation to FIG. 2.

10. The method according to claim 8, wherein the second transfer function comprises the same relationships between the average droplet size, the Wilson Point expansion rate, and the Wilson Point pressure value as that illustrated in FIG. 4.

11. The method according to claim 8, wherein the second transfer function provides for an inverse relationship between the Wilson Point expansion rate and the average droplet size.

12. A system for calculating moisture loss in a steam turbine operating under wet steam conditions, the system comprising:
means for, assuming equilibrium expansion, calculating a flow field initialization to determine initial pressure values, initial expansion rate, initial velocity values at an inlet and an exit of each of a plurality of bladerows in the steam turbine, and initial enthalpy values through each of the plurality of bladerows in the steam turbine;
means for, using the initial pressure values, the initial velocity values, and the initial enthalpy values, calculating an initial subcooling ΔT value through each of the plurality of bladerows of the steam turbine;
means for calculating an Wilson Point critical subcooling ΔT value through each of the plurality of bladerows of the steam turbine required for spontaneous nucleation to occur based on the initial pressure value and the initial expansion rate; and
means for comparing the initial subcooling ΔT values to the Wilson Point critical subcooling ΔT values to determine where spontaneous nucleation occurs through the plurality of bladerows of the steam turbine.

13. The system according to claim 12, further comprising a first transfer function, the first transfer function being derived by using at least a plurality of measured Wilson critical subcooling ΔT values from available experimental data and correlating the Wilson Point critical subcooling ΔT value as a function of a Wilson Point expansion rate and a Wilson Point pressure value; and
means for calculating the Wilson Point critical subcooling ΔT value with the first transfer function by using the initial expansion rate as the Wilson Point expansion rate and the initial pressure value as the Wilson Point pressure value.

14. The system according to claim 13, wherein the measured Wilson critical subcooling ΔT values from the available experimental data include at least one of the sources described herein in relation to FIG. 2.

15. The system according to claim 13, wherein the first transfer function comprises the same relationships between the Wilson Point critical subcooling ΔT value, the Wilson Point expansion rate, and the Wilson Point pressure value as that illustrated in FIG. 3.

16. The system according to claim 13, wherein the first transfer function provides a direct relationship between the Wilson Point critical subcooling ΔT value and the Wilson Point expansion rate.

17. The system according to claim 12, wherein the means for comparing the initial subcooling ΔT value to the Wilson Point critical subcooling ΔT to determine where spontaneous nucleation occurs through each of the plurality of bladerows of the steam turbine further includes:
means for determining that spontaneous nucleation does not occur within one of the plurality of bladerows if the initial subcooling ΔT value is less than the Wilson Point critical subcooling ΔT; and
means for determining that spontaneous nucleation does occur within one of the plurality of bladerows if the initial subcooling ΔT value is greater than or equal to the Wilson Point critical subcooling ΔT.

18. The system according to claim 12, further comprising means for calculating an average droplet size in the bladerow where spontaneous nucleation occurs.

19. The system according to claim 18, further comprising a second transfer function, the second transfer function being derived by using at least a plurality of measured droplet sizes from available experimental data and correlating the average droplet size as a function of a Wilson Point expansion rate and a Wilson Point pressure value; and
means for calculating the average droplet size with the second transfer function by using the initial expansion rate as the Wilson Point expansion rate and the initial pressure value as the Wilson Point pressure value.

20. The system according to claim 19, wherein the measured nucleation droplet sizes from the available experimental data includes at least one of the sources described herein in relation to FIG. 2.

21. The system according to claim 19, wherein the second transfer function comprises the same relationships between the average droplet size, the Wilson Point expansion rate, and the Wilson Point pressure value as that illustrated in FIG. 4.

22. The system according to claim 19, wherein the second transfer function provides for an inverse relationship between the Wilson Point expansion rate and the average droplet size.

23. The system according to claim 12, further comprising means for calculating a nucleation loss based on an entropy increase calculated from the metastable steam properties of IAPWS-IF97 formulation.
